(19) United States
(12) Patent Application Publication
(10) Pub. No.: US 2008/0307988 A1
(43) Pub. Date: Dec. 18, 2008

(54) Central manifold supply for spray bar

(75) Inventors: Ken Francis Blaney, Rochester, NH (US); Michael Thomas Woroniak, Rochester, NH (US)

Correspondence Address: Davidson, Davidson & Kappel, LLC, 485 7th Avenue, 14th Floor, New York, NY, 10018, US

(73) Assignee: Goss International Americas, Inc., Dover, NH (US)

(21) Appl. No.: 12/228,479

(22) Filed: Aug. 13, 2008

Related U.S. Application Data
(62) Division of application No. 11/210,033, filed on Aug. 23, 2005.

(51) Int. Cl. B41L 25/06

(52) U.S. Cl. 101/148

(57) ABSTRACT

A spray bar includes a manifold or multiple manifolds located on the spray bar. More specifically, the spray bar includes one or more manifolds connected to dedicated feed lines each having a spray head, resulting in improved lateral spray distribution.

### CROSS-REFERENCE TO RELATED APPLICATIONS

This application is a divisional of U.S. patent Ser. No. 11/210,033, filed Aug. 23, 2005, and which is hereby incorporated by reference herein. This application is related to IMPROVED SPRAY PATTERN VALVE BODY, U.S. application Ser. No. 11/209,597 and SPRAY BAR CONTROL FOR ACCOMMODATING MULTIPLE WIDTHS, U.S. application Ser. No. 11/210,039, the entire disclosures of which are hereby incorporated by reference.

### FIELD OF THE INVENTION

The present invention relates to a printing press and more particularly to a spray bar for delivering fluids.

### BACKGROUND

It is well known in the printing industry to use spray bars to deliver fluid to a plate cylinder. Typically, a spray bar is connected to a fluid source via a source line. The fluid travels through the source line to the spray bar and through the spray heads to a plate cylinder via dampener rolls. The spray bar uses a common feed line to connect the source line to spray heads, which are arranged in a series along the common feed line, with one end of the common feed line connected to the source line.

Spray heads arranged in series along a common feed line experience a decrease in fluid pressure along the series of spray heads. That is, each spray head experiences a lower fluid pressure than the spray head or heads closest to the source line. Thus, the largest pressure difference occurs between the first spray head and the last spray head on the spray bar. This is caused, in part, by the different distance the fluid travels through the common feed line from the first spray head to the last spray head. The difference in pressure is also caused by the discharge of fluid through each proceeding spray head. Because lateral spray distribution produced by a spray bar is highly influenced by pressure, the difference in pressure between multiple spray heads contained in the spray bar result in the lateral uniformity of the spray pattern being compromised.

### SUMMARY OF THE INVENTION

In accordance with an embodiment of the present invention, a spray bar is provided which includes a manifold having an inlet, and a plurality of spray heads, each spray head connected to the manifold in a corresponding feed line. The spray heads can be provided in a linear arrangement, and the manifold is centrally located relative to the linearly arranged spray heads. Preferably, each spray head is a termination point in the spray bar for fluid from the manifold, prior to the fluid being sprayed from each spray head.

In accordance with a further embodiment of the present invention, the spray bar further includes a second manifold having a second inlet, and a common feed line connected to the respective inlets of the two manifolds. The spray bar further includes a second plurality of spray heads, and each spray head of the second plurality of spray heads is connected to the second manifold via a corresponding feed line.

### BRIEF DESCRIPTION OF THE DRAWINGS

Further objects, features and advantages of the invention will become apparent from the following detailed description taken in conjunction with the accompanying drawings, in which:

FIG. 1 illustrates a prior art spray bar;

FIG. 2 shows lateral spray distribution of the prior art spray bar illustrated in FIG. 1;

FIG. 3 illustrates a prior art spray bar and flow formulas.

FIG. 4 shows a typical dampening system of a printing unit of a printing press;

FIG. 5 (a, b,) illustrates a spray bar arranged in accordance with an embodiment the invention;

FIG. 6 shows lateral spray distribution of the spray bar illustrated in FIG. 5 in accordance with the invention; and

FIG. 7 illustrates a spray bar and dedicated feed line lengths in accordance with the invention.

FIG. 8 shows further embodiments of the present invention.

### DETAILED DESCRIPTION

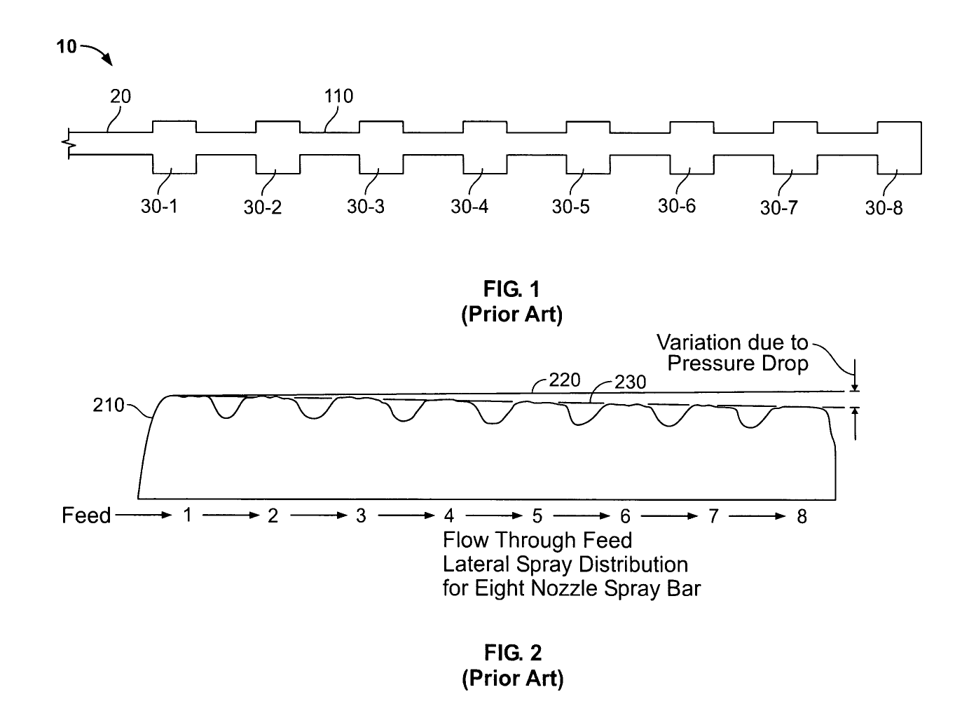

A prior art spray bar has spray heads arranged in series along a common feed line. Referring to FIG. 1, prior art spray bar 10 is connected to a fluid source (not shown) via a source line 20. Spray bar 10 uses a common feed line 110 to connect source line 20 to spray heads 30-1 through 30-8. The spray heads 30-1 through 30-8 are arranged in series along common feed line 110, with source line 20 connected to one end of common feed line 110. The fluid travels through source line 20 to spray bar 10 and through spray heads 30-1 through 30-8 and onto a dampener roll which transmits the fluid to one or more further dampener rolls (collectively referred to herein as a dampener roll arrangement) which in turn transmit the fluid to a printing plate of a plate cylinder.

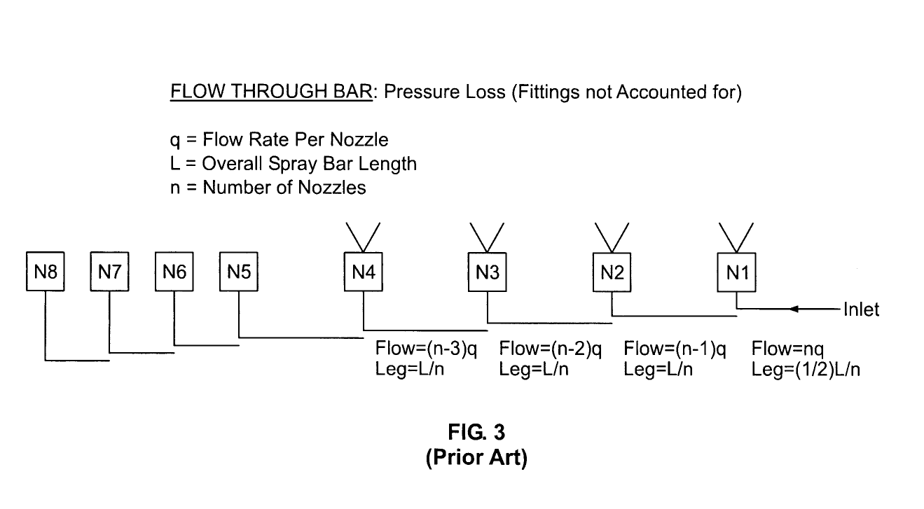

Referring to FIG. 2, spray heads 30-1 through 30-8 arranged in series along common feed line 110 experience a decrease in fluid pressure along the series of spray heads. That is, each spray head 30-1 through 30-8 experiences a lower fluid pressure than the spray head(s) closest to main feed line 20, as illustrated in FIG. 2. FIG. 2 shows a lateral spray distribution pattern of prior art spray bar 10. More specifically, it shows the relationship between fluid pressure and spray heads 30-1 through 30-8. Line 210 represents the spray distribution of the fluid through spray heads 30-1 through 30-8. The largest variation in the lateral spray distribution occurs between spray head 30-1 and spray head 30-8, as shown by lines 220 and 230. Line 220 is a horizontal line representing the lateral spray distribution from spray head 30-1. Line 230 is a sloped line drawn across the tops of line 210, which represents the lateral spray distribution of prior art spray bar 10. Line 230 thus illustrates the large decrease in fluid pressure as spray heads 30-1 through 30-8 get farther away from main feed line 20. Thus, the farther a spray head is positioned from its source line, the lower the fluid spray pressure at that spray head.

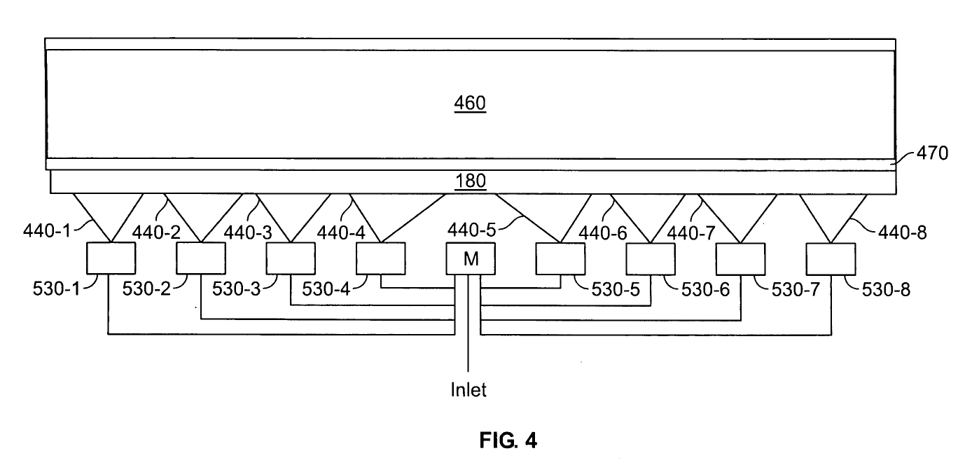

FIG. 3 illustrates prior art spray bar 10 having spray heads (denoted N1 through N8) and formulas for calculating flow rate. In this regard, in FIG. 3, Flow Rate=q×n, where n=number of nozzles/spray heads, L=overall spray bar length, and q=the desired flow rate per nozzle/spray head.

Table 1, shown below, provides flow values for the spray heads in illustrative spray bar 10. In this illustration, spray bar 10 is assumed to be 1600 mm in length and each Leg is assumed to be 200 mm long as the 8 spray heads are disposed equal length from each other along spray bar 10.

TABLE 1
8 Nozzle Bar (L = 1600 mm, Leg = 200 mm)
Flow: Leg:

| | | |
|---|---|---|
| End to N1 = (5 ml/s)(8) = 40 mL/s = | 144 | L/h |
| N1 to N2 = (5)(7) = 35 mL/s = | 126 | L/h |
| N2 to N3 = (5)(6) = 30 mL/s = | 108 | L/h |
| N3 to N4 = (5)(5) = 25 mL/s = | 90 | L/h |
| N4 to N5 = (5)(4) = 20 mL/s = | 72 | L/h |
| N5 to N6 = (5)(3) = 15 mL/s = | 54 | L/h |
| N6 to N7 = (5)(2) = 10 mL/s = | 36 | L/h |
| N7 to N8 = (5)(1) = 5 mL/s = | 18 | L/h |

Table 2, shown below, provides pressure drop values, in bars, calculated for spray heads N1 through N8. For purposes of illustration, calculations are provided assuming 5 mm inner-diameter feed lines. Generally, the farther the spray head is from the inlet, the larger the pressure drop, as indicated by the data in the column denoted Cumulative.

TABLE 2
Pressure Drop (Bar, 1 Bar = 14.5 psi)

5 mm ID

| | Leg | Cumulative |
|---|---|---|
| End to N1 | 0.013 | 0.013 |
| N1 to N2 | 0.020 | 0.033 |
| N2 to N3 | 0.016 | 0.049 |
| N3 to N4 | 0.011 | 0.060 |
| N4 to N5 | 0.008 | 0.068 |
| N5 to N6 | 0.005 | 0.073 |
| N6 to N7 | 0.002 | 0.075 |
| N7 to N8 | 0.001 | 0.076 |

Table 3 provides calculated values, based on Table 2, for the maximum total pressure loss from the inlet of illustrative spray bar 10 to any spray head and the maximum pressure difference between any two spray heads.

TABLE 3
$\frac{Max Total Pressure Loss From Inlet To Nozzle}{5 mm ID \text{:} 0.076 bar ( 1.1 psi )}$
$\frac{Max Pressure Difference Between Nozzles}{5 mm ID \text{:} 0.063 bar ( 0.914 psi )}$

The present invention provides improved lateral distribution of a spray bar. In accordance with a embodiment of the invention, the spray bar has a centrally located manifold or multiple manifolds located on the spray bar resulting in minimal spray pattern variations among spray heads.

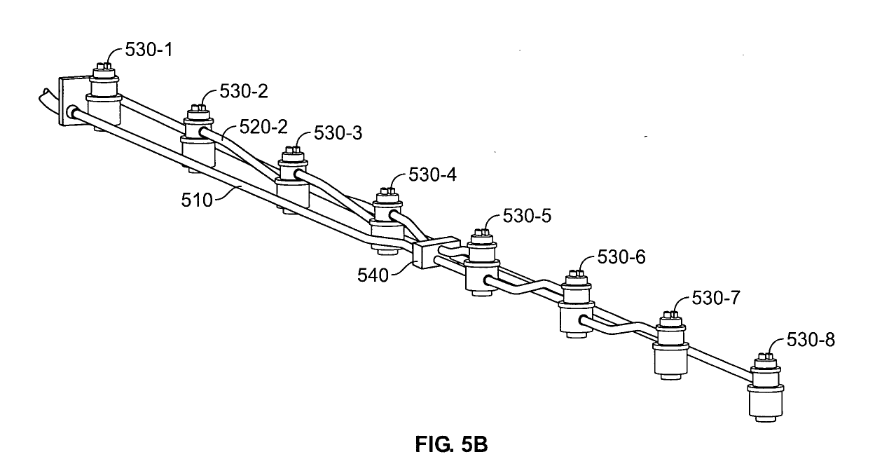

FIG. 5(a), and FIG. 5(b), illustrate a spray bar 500 embodying the principles of the invention for improving lateral spray distribution. As shown in FIG. 5(a, b), spray bar 500 includes a main feed line 510, manifold 540, dedicated feed lines 520-1 through 520-N and spray heads 530-1 through 530-N, where N is a predetermined number.

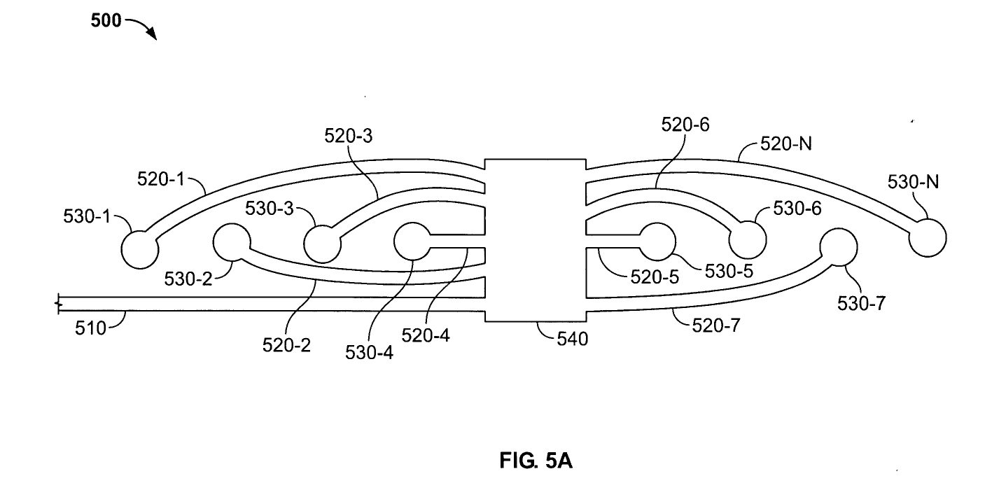

In this example of FIG. 5, N equals 8. Thus, spray bar 500 has 8 dedicated feed lines 520-1 through 520-8 and 8 spray heads 530-1 through 530-8. Spray bar 500 is connected to a fluid source and source line (both not shown) via main feed line 510. The fluid can be for example a solution, such as a fountain solution for a damping system, which flows from the source and through the source line and main feed line 510. After passing through main feed line 510, the fluid enters manifold 540. It should be realized that the source line could be directly connected to manifold 540, rather than to main feed line 510, as in this example. Manifold 540 is connected to dedicated feed lines 520-1 through 520-8 which guide fluid flow to spray heads 530-1 through 530-8. The fluid passes from manifold 540 through dedicated feed lines 520-1 through 520-8 and out spray heads 530-1 through 530-8 onto a dampener roll which transmits the fluid to one or more further dampener rolls (collectively dampener roll arrangement 180) which in turn transmits the fluid to a printing plate 470 of plate cylinder 460 as illustrated in FIG. 4. Advantageously, the fluid is terminated in each spray head, rather than only in the spray head farthest from the source line, as in the prior art.

FIG. 4 is a block diagram showing a typical dampening system of a printing unit including spray heads 530-1 through 530-8 in accordance with the invention arranged to spray a fluid 440-1 through 440-8, such as a fountain solution, onto a dampener roll in dampener roll assembly 180, which dampener roll assembly 180 transmits the fluid onto a printing plate 470 of a plate cylinder 460 of a printing unit. As shown, the spray heads are arranged axially relative to the plate cylinder (i.e., in the direction of the axis of the plate cylinder).

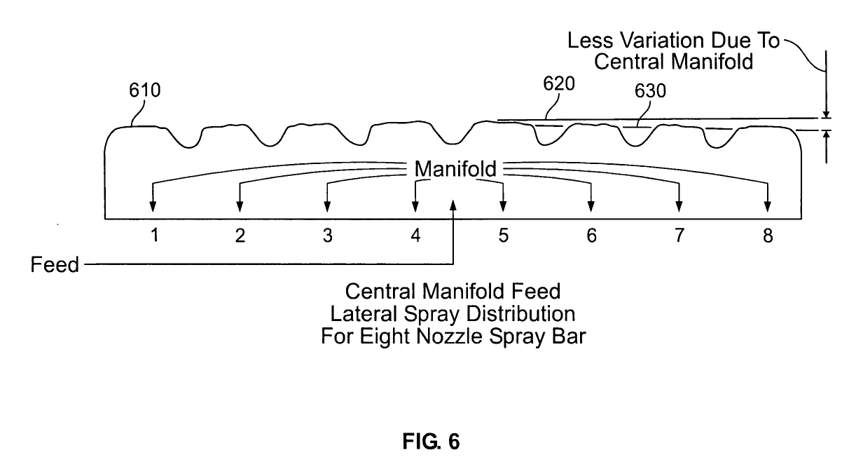

FIG. 6 shows a lateral spray distribution pattern of spray bar 500 in accordance with the invention. More specifically, FIG. 6 shows the relationship between fluid pressure and spray heads 530-5 through 530-8. Line 610 represents the spray distribution of the fluid through spray heads 530-5 through 530-8. As shown in FIG. 6, line 620 is a horizontal line representing the lateral spray distribution from spray head 530-5. Line 630 is a sloped line drawn across the tops of line 610 representing spray distribution from spray bar 500. Line 630 illustrates a slight downward slope, indicating a decrease in fluid pressure as spray heads 530-5 through 530-8 get farther away from manifold 540. It should be noted that due to the general symmetry of the embodiment of the spray bar, data and calculations representing half of the spray bar are discussed to simplify the discussion.

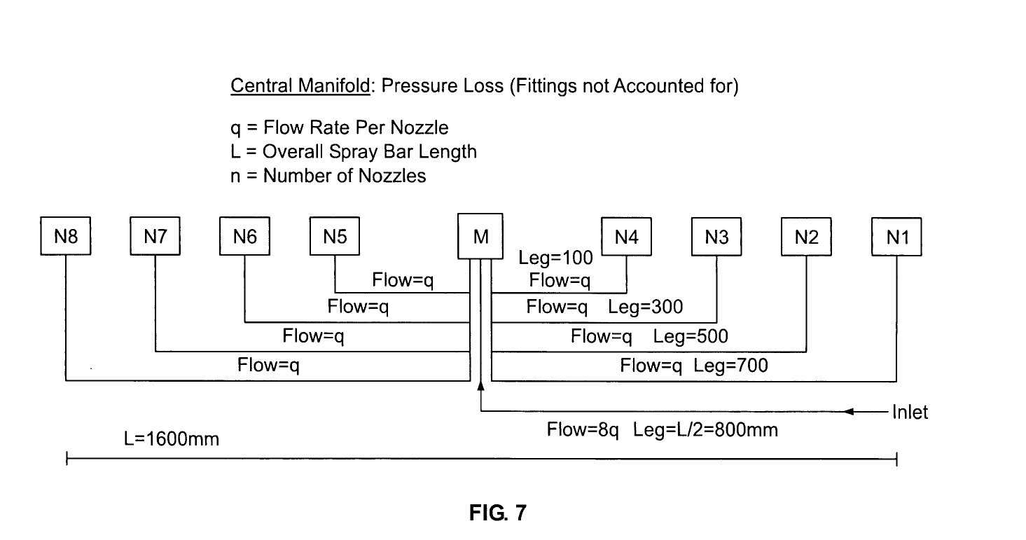

FIG. 7 illustrates spray bar 500 of FIG. 5(a, b), having spray heads 530-1 through 530-8 (denoted N1 through N8), a manifold 540 (denoted as M) and showing leg length for each dedicated feed lines 520-1 through 520-4. In this embodiment, dedicated feed lines 520-1 through 5204 have lengths 700 mm, 500 mm, 300 mm, and 100 mm respectively, and main line feed 510 has a length of 800 mm.

Table 4 shows the flow rate and the decrease in pressure for spray heads in an embodiment of a spray bar in accordance with FIG. 5-7 wherein the system is assumed to have either a 5 mm inner diameter (“ID”) feed line with 5 mm ID branch lines. Table 5 includes calculations of the maximum total pressure loss from the inlet of an embodiment of a spray bar to spray heads and the maximum pressure difference between spray heads. As one of ordinary skill in the art will appreciate, the values listed in Tables 1-5 could be calculated for other flow rates and feed line diameters using conventional fluid dynamics techniques.

TABLE 4
Pressure Drop (Bar, 1 Bar = 14.5 psi)

5 mm Feed / 5 mm Branch

| Flow (L/h) | Leg | Cumulative |
|---|---|---|
| Inlet to M: 144 L/h | 0.103 | 0.103 Bar |
| M to N1: 18 | 0.002 | 0.105 |
| M to N2: 18 | 0.002 | 0.105 |
| M to N3: 18 | 0.001 | 0.104 |
| M to N4: 18 | 0.000 | 0.103 |

TABLE 5
$\frac{Max Total Pressure Loss From Inlet To Nozzle}{5 mm ID \text{:} 0.105 bar ( 1.5 psi )}$
$\frac{Max Pressure Difference Between Nozzles}{5 mm ID \text{:} 0.002 bar ( 0.029 psi )}$

It should be noted that the drop in pressure from the manifold (denoted M) to the various spray heads or nozzles (denoted N1 through N4) differ by a maximum of 0.002 bars as indicated in Table 4 and table 5. This results in minimal spray pattern variations among spray heads. In contrast, referring to prior art table 2 and 3, the prior art spray bar pressure differs by a maximum of 0.063 bars, resulting in significantly larger spray pattern variations. Moreover, although the maximum total pressure drop from the inlet to any nozzle is larger for the embodiment of FIG. 5 than the embodiment of FIG. 3 in this illustration (0.105 bar vs. 0.076) it is still an acceptable pressure drop.

It should be appreciated that the overall pressure drop from the inlet to nozzle is not critical so long as it does not prevent sufficient pressure from reaching the nozzles. In contrast it is very important to reduce the variation of pressure between nozzles as that can cause uneven fluid distribution at the printing plate.

The foregoing merely illustrates the principles of the invention. It will thus be appreciated that those skilled in the art will be able to devise numerous other arrangements which embody the principles of the invention and are thus within its sprit and scope.

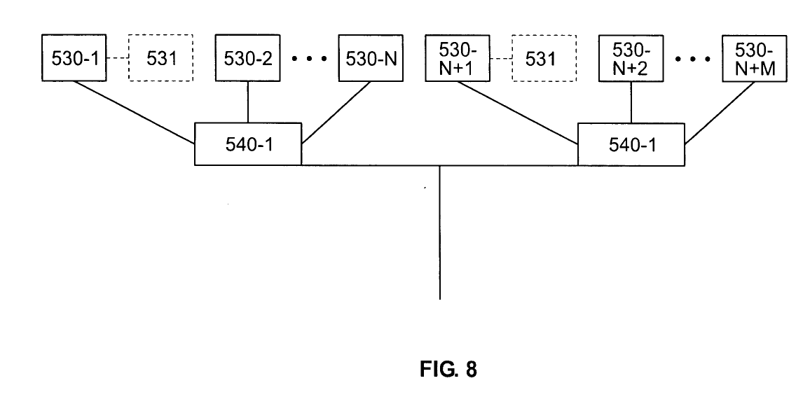

For example, based on the above disclosure, it is apparent that the principles of the invention can readily accommodate various spray bar configurations and two or more manifolds can be utilized to achieve the benefits of the invention as illustrated in FIG. 8

In addition, based on the disclosure, it is apparent that spray bar 500 can readily accommodate more or less dedicated feed lines and spray heads depending on the configuration of spray bar 500. Moreover, it is possible to connect one or more of the spray heads 530 to a further spray head 531 in series (dashed lines in FIG. 8). Although this will likely result in a larger pressure drop variation between spray head 531 and spray heads 530-1 through 530-n because of the series connection.

1-19. (canceled)

20. A printing press comprising:
a printing press spray bar including a manifold having an inlet for a dampening solution and a plurality of dampening solution spray heads, each spray head connected to the manifold via a corresponding feed line;
a dampener roll assembly including a dampener roll; and
a plate cylinder, the spray bar spraying dampening solution onto the dampener roll and the damper roll assembly transmitting the dampening solution onto the plate cylinder.

21. The printing press spray bar of claim 20 wherein the spray heads are in a linear arrangement.

22. The printing press of claim 21 wherein the manifold is centrally located relative to the linearly arranged spray heads

23. The printing press of claim 20 further comprising a main feed line connected to the inlet.

24. The printing press of claim 20 wherein an equal number of the spray heads are disposed on opposite sides of the manifold.

25. The printing press of claim 20 wherein at least one of the plurality of spray heads is connected in series to a further spray head.

26. The printing press of claim 20 wherein the printing press spray bar includes:
a second manifold having a second inlet,
a common feed line connected to the respective inlets of the two manifolds; and
a second plurality of dampening solution spray heads, each spray head of the second plurality of dampening solution spray heads connected to the second manifold via a corresponding feed line, the second plurality of dampening solution spray heads spraying dampening solution onto the dampener roll.

27. The printing press of claim 26 wherein the spray bar includes an equal number of the spray heads are disposed on opposite sides of the two manifolds.

28. A printing press comprising:
a printing press spray bar including a manifold having an inlet for a dampening solution and a plurality of dampening solution spray heads, each spray head connected to the manifold via a corresponding feed line, each spray head being a termination point for dampening solution from the manifold, prior to said dampening solution being sprayed from said each spray head;
a dampener roll assembly including a dampener roll; and
a plate cylinder, the spray bar spraying dampening solution onto the dampener roll and the damper roll assembly transmitting the dampening solution onto the plate cylinder.

29. The printing press of claim 28 wherein the spray heads are in a linear arrangement.

30. The printing press of claim 29, wherein the manifold is centrally located relative to the linearly arranged spray heads

31. The printing press of claim 28 further comprising a main feed line connected to the inlet.

32. The printing press of claim 28 wherein an equal number of the spray heads are disposed on opposite sides of the manifold.

33. The printing press of claim 28 wherein the printing press spray bar includes:
a second manifold having a second inlet,
a common feed line connected to the respective inlets of the two manifolds; and
a second plurality of spray heads, each spray head being a termination point for dampening solution from the second manifold, the second plurality of dampening solution spray heads spraying dampening solution onto the dampener roll.

34. The printing press spray bar of claim 33 wherein an equal number of the spray heads are disposed on opposite sides of the two manifolds.
